(19) United States
(12) Patent Application Publication
(10) Pub. No.: US 2009/0140029 A1
(43) Pub. Date: Jun. 4, 2009

(54) METHOD AND DEVICE FOR WIRE BONDING

(76) Inventors: Ernst WANDKE, Geretsried (DE); Christoph Laumen, Munich (DE); Pang Ling Hiew, Kuala Lumpur (MY); Boon Ann Tan, Singapore (SG)

Correspondence Address: The BOC Group, Inc., 575 MOUNTAIN AVENUE, MURRAY HILL, NJ, 07974-2082, US

(21) Appl. No.: 12/323,666

(22) Filed: Nov. 26, 2008

(30) Foreign Application Priority Data
Nov. 29, 2007 (DE) 102007057429.2

(51) Int. Cl. B23K 35/38; B23K 31/02

(52) U.S. Cl. 228/180.5; 228/45

(57) ABSTRACT

The invention provides a device for wire bonding with a copper-containing bonding wire for connecting a component to a support, wherein provision is made on the component as well as on the support for at least one bond pad, encompassing a guide for the bonding wire and a device for melting a part of a bonding wire, which is provided for a connection to one of the bond pads, wherein the guide for the bonding wire is embodied in such a manner that the melted part of the bonding wire is brought into contact in each case with at least one bond pad in a bonding chamber, characterized in that provision is made for at least one plasma nozzle, with part of the bonding wire provided for the connection to the bond pad can be acted upon by a plasma and/or the bond pad can be acted upon by a plasma and/or the bonding chamber can be acted upon by a plasma. The invention also relates to a method for wire bonding.

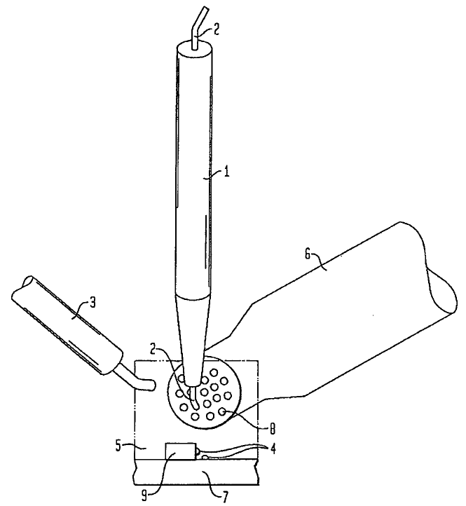

The instant invention relates to a device for wire bonding with a copper-containing bonding wire. Furthermore, the instant invention relates to a method for wire bonding.

A number of methods and devices for wire bonding are known. The wire bonding represents a connection method by means of which the electrical engineering components, in particular microelectronic components or non-electronic (micro) components are provided with electrical connections and/or are connected to a chip using very thin wires, the so-called bonding wires.

The known methods use gold wire or a gold alloy as bonding wire for the most part. Furthermore, aluminum wire and also copper wire is used.

In the past, however, the use of copper wire or copper-containing bonding wire, has shown difficulties, which seem to be caused by oxides attached there. Typically, copper is at least slightly oxidized. The conductivity of a copper-containing bonding wire and the joint strength of a bonding connection are reduced due to the presence of the oxides.

U.S. Pat. No. 6,234,376 discloses a method and a device for wire bonding using a protective gas, which is to reduce the formation of an oxide and to thus enable the use of copper or aluminum wire as bonding wire.

Furthermore, the term copper-containing bonding wire is to comprise pure copper wire as well as wire alloys comprising a copper content of at least 10%.

It is the object of embodiments of the instant invention to provide an improved device and an improved method for wire bonding by means of a copper-containing bonding wire.

The object is solved according to the device in that provision is made for at least one plasma nozzle, with the help of which the part of the bonding wire and/or of the bond pad and/or of the bonding chamber, which are provided for the connection to the bond pad, can be acted upon by a plasma.

Due to the presence of the plasma, a reduction and activation of the bonding wire and bond pad surface takes place. The partners of the connection method, which are acted upon by the plasma, are cleaned and the surface thereof is activated. This leads to particularly good results in response to the wire bonding by means of a device according to the invention. The presence of the plasma can thus reduce available oxides of the part of the bonding wire (the melted part of the bonding wire), which is provided for the connection to the bond pad and/or of the bond pad and/or of the bonding chamber and can thus prevent a regeneration thereof for the most part and can thus enable a connection of high quality and reliability, which is mostly free from oxides.

Preferably, the plasma nozzle is mounted in such a manner that the melted part of the bonding wire, which is provided for the connection to the bond pad, is acted upon by the plasma. According to a development of the invention, the plasma nozzle is mounted in such a manner that the bond pad is additionally or alternatively acted upon by the plasma. An embodiment of the invention provides for the entire bonding chamber, thus at least the melted part of the bonding wire and the bond pad and, if applicable, the adjoining part of the device, such as, e.g., the device for melting, are acted upon by the plasma and the plasma is distributed in such a manner, respectively, that said components are at least partially surrounded by the plasma.

The orientation and/or positioning of the plasma nozzle can be adjusted and can be chosen, respectively, so as to be goal-oriented so that a plasma jet, which leaves the plasma nozzle, arrives at a previously chosen region as the target. Regions and components, respectively, of the device were already mentioned. The plasma nozzle can be embodied as a nozzle pair. An embodiment with, e.g., 3, 4, 5 of a plurality of nozzles next to one another, as so-called nozzle batch, has also proven to be useful in certain cases. The plasma nozzle(s) can also encompass a plurality of delivery ports for expanding the plasma jet.

It was possible to establish the following plasma components for the instant invention: hydrogen, argon and mixtures thereof as well as mixtures of hydrogen with nitrogen, also with a further addition of argon.

The plasma may be generated under atmospheric pressure. A special chamber, in which the plasma is generated, is therefore not absolutely necessary. However, it is also possible that a low pressure plasma is embodied, for example in response to a pressure of less than 10 mbar.

The orientation of the plasma nozzle is thus embodied so as to be adjustable so that it is thus made possible for a plasma jet, which leaves the plasma nozzle, to arrive at a previously chosen region as the target.

According to a further embodiment of the invention, the plasma nozzle is mounted in the region, in which the bonding wire leaves the guide. The plasma jet, e.g., is thus directed to the bonding wire. The plasma jet may be oriented at right angles to the longitudinal axis of the bonding wire.

According to another embodiment of the invention, provision is made for a second plasma nozzle. This second plasma nozzle may be oriented in such a manner that it acts upon a different region than the first plasma nozzle. In the alternative, an admission of the same region can be sensible or a directly adjoining region can be acted upon by the second plasma nozzle so that, in so doing, the admitted region increases.

The plasma nozzle is connected to a plasma generating unit, for example, which in turn is connected to a gas supply, wherein the plasma generating unit encompasses at least two electrodes, between which an electric discharge can be effected, with the help of which a plasma is generated in the process gas, which is supplied via the gas supply.

According to another embodiment of the invention, the second plasma nozzle is directed to the bond pad, in particular at right angles to the bond pad. The described positive effects of the plasma are attained by means of this embodiment in a particularly distinct manner.

The instant invention is suitable for the wire bonding in general and in particular for the ball bonding and also for the wedge bonding.

An embodiment of the invention, which is suitable for the ball bonding, shall be initially described herein in detail as an example: when ball bonding, a device for wire bonding is provided with a guide for the bonding wire, which is embodied as capillaries and which encompasses a capillary head, through which the bonding wire is guided. Furthermore, the device encompasses a tube for receiving a gas atmosphere, which encompasses a first and second opening, wherein the two openings can be aligned on top of one another in a direction, which is transversal to the axis of the tube and wherein at least the tip of the capillary head can be guided through the openings. Furthermore, provision is made for a device for melting the end of the bonding wire, which projects from the tip of the capillary head, so that this end of the bonding wire is formed in a spherical manner and can be brought into contact with a bond pad by passing through at least the tip of the capillary head.

In the context of this example, the plasma nozzle is mounted in the tube parallel to the axis of the tube. In the alternative, the plasma nozzle can be mounted so as to be inclined against the axis of the tube. In particular, it can be inclined in such a manner that the jet direction of the plasma jet leaving the plasma nozzle faces the bond pad. In a particular development, the plasma nozzle can be embodied and mounted in such a manner that that a region, which is acted upon by the plasma jet, comprises the end of the bonding wire and the flame discharge of the device for melting the end of the bonding wire, which projects from the tip of the capillary head. Other embodiments of the device for melting the bonding wire will be described later.

As a further example, an embodiment of the invention, which is suitable for the wedge bonding shall be described in detail as a further example: when wedge bonding, the bonding wire is also guided by means of a capillary or by means of a bonding wedge. However, provision is not made for the embodiment of a spherical, melted end of the bonding wire. Instead, the bonding wire is melted at any selectable location and is then brought into contact with the bond pad.

For many applications, a combination of ball and wedge bonding is used, where a first connection is embodied as ball bond and a second connection is embodied as wedge bond.

The guide for the bonding wire is embodied so as to be movable, in particular so as to be movable vertically and/or horizontally.

A number of devices have proven to be suitable for melting the bonding wire for the instant invention. Two possibilities shall be singled out and described in more detail below:

As a device for melting the bonding wire, provision can be made for an EFO device (electric flame off device), which encompasses an electrode, which is mounted in such a manner that it enables an electric arc discharge.

In the alternative, a hydrogen-rich hydrogen-oxygen flame can serve as a device for melting the bonding wire, which is embodied in such a manner that it heats and melts the part of the bonding wire, which is provided for a connection to the bond pad. In the case of a ball bond, the end of the bonding wire is thereby to be deformed in a spherical manner.

Preferably, a plasma generating unit is available to generate the plasma from the plasma nozzle. The plasma generating unit encompasses the following components: a gas supply for the plasma generation, which is in contact in each case with a reservoir for hydrogen and/or argon and/or nitrogen. If applicable, a mixing unit can be used for premixing a desired composition. The inflow of process gas via the gas supply is limited, in particular by means of choking. Provision is made for a total passage of less than 3 m³ per hour. On the one hand, the plasma generating unit is thereby connected to the plasma nozzle and, on the other hand, to the gas supply, wherein the plasma generating unit encompasses at least two electrodes, between which an electric discharge is brought about and a plasma is generated in a process gas, which is provided via the gas supply.

According to a development of the invention, a plasma temperature of up to 200° C. is aimed for. A temperature in the range of from 80 to 120° C. has proven to be useful.

With reference to the method, the posed object is solved in that at least one plasma nozzle is used, with the help of which the part of the bonding wire, which is provided for the connection to the bond pad and/or the bond pad and/or the bonding chamber, are acted upon by a plasma.

For melting the bonding wire as well as for generating the plasma, reference is made in an exemplary manner to the possibilities of the embodiment, which have already been described.

A plasma jet leaving the plasma nozzle is adjusted in a target-oriented manner so that a region, which was chosen in advance, is acted upon by the plasma as the target.

The instant invention is suitable for ball bonding and for wedge bonding methods and method steps, respectively. The invention can also be used in assembled bonding methods, which in each case encompass method steps of the ball bonding and of the wedge bonding.

The instant invention encompasses a large number of advantages, of which an increase of the reliability and the constant quality of the connection, e.g., are some.

The invention embodiments will be defined in more detail below by means of the exemplary embodiment illustrated in the FIGURE. The FIGURE shows a device for wire bonding according to the invention.

In detail, the FIGURE shows a guide 1 for a copper-containing bonding wire 2 and a device 3 for melting a part of a bonding wire 2, which is provided for a connection to the microchip 9. The microchip 9 is to be connected to a support 7 as basis. For example, the support 7 can be embodied as a printed circuit board 7. Bond pads 4, which are connected by means of fine wires (bonding wire 2) during the bonding, are located on both components (microchip 9 and support 7).

The guide 1 for the bonding wire 2 is embodied in such a manner that the melted part of the bonding wire 2 is brought into contact with a bond pad 4 in a bonding chamber 5. According to the invention, provision is made for a plasma nozzle 6, with the help of the part of the bonding wire 2, which is provided for the connection to the bond pad 4 of the microchip 9, is acted upon with plasma. Here, the plasma nozzle 6 encompasses a plurality of delivery ports 8 for expanding the plasma jet. The guide 1 is embodied so as to be capable of being moved vertically and can be lowered for connecting the bonding wire to the bond pads 4.

What is claimed is:

1. A device for wire bonding with a copper-containing bonding wire for connecting a component to a support, wherein provision is made in each case on the component as well as on the support for at least one bond pad encompassing a guide for the bonding wire and a device for melting a part of a bonding wire, which is provided for a connection to one of the bond pads, wherein the guide for the bonding wire is embodied in such a manner that the melted part of the bonding wire is brought into contact in each case with at least one bond pad in a bonding chamber, characterized in that provision is made for at least one plasma nozzle, with part of the bonding wire provided for the connection to the bond pad can be acted upon by plasma and/or the bond pad can be acted upon by plasma and/or the bonding chamber can be acted upon by a plasma.

2. The device according to claim 1, characterized in that the orientation of the plasma nozzle can be adjusted so that a plasma jet leaving said plasma nozzle arrives at a previously chosen region as a target.

3. The device according to claim 1, characterized in that the plasma nozzle is mounted in the region, where the bonding wire leaves the guide.

4. The device according to claim 1, characterized in that provision is made for a second plasma nozzle.

5. The device according to claim 4, characterized in that the second plasma nozzle is directed to the bond pad, in particular at right angles to the bond pad.

6. A method for wire bonding with a copper-containing bonding wire for connecting a component to a support, wherein provision is made in each case on the component as well as on the support for at least one bond pad, where the bonding wire is brought into an effective connection with a device for melting the bonding wire using a guide so that a part of the bonding wire, which is provided for a connection to one of the bond pads, is melted and the melted part of the bonding wire is brought into contact in each case with at least one bond pad in a bonding chamber, characterized in that at least one plasma nozzle is used, with part of the bonding wire provided for the connection to the bond pad is acted upon by a plasma and/or the bond pad is acted upon by a plasma and/or the bonding chamber is acted upon by a plasma.

7. The method according to claim 7, characterized in that a plasma jet leaving the plasma nozzle is adjusted so as to be target-oriented so that a previously chosen region is acted upon by the plasma as the target.

8. The method according to claim 7, characterized in that a second plasma nozzle is used.

9. The method according to claim 7, characterized in that a plasma jet, which leaves the second plasma nozzle, is directed to the bond pad, in particular at right angles to the bond pad.
